(19) United States
(12) Patent Application Publication
(10) Pub. No.: US 2007/0040986 A1
(43) Pub. Date: Feb. 22, 2007

(54) DEVICE AND METHOD FOR FILLING LIQUID CRYSTAL

(76) Inventor: Chih-Chien Chou, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,761

(22) Filed: Aug. 16, 2005

(51) Int. Cl. G02F 1/1341

(52) U.S. Cl. 349/189

(57) ABSTRACT

A device and a method for filling the liquid crystal material to form a liquid crystal layer onto a substrate are provided. The device has a stage and a jet-print module. The substrate is mounted on the stage and the jet-print module is used for spraying the liquid crystal material onto the substrate.

### BACKGROUND OF THE INVENTION

1. Field of the Invention

The present invention relates to a device and method for fabricating a liquid crystal display panel. More particularly, the present invention relates to a device and method for filling liquid crystal.

2. Description of the Related Art

Among many kinds of commercial display devices, liquid crystal display (LCD) has gradually predominated in the market due to its high image quality, high spatial utilization, low power consumption, low radiation hazard properties. The liquid crystal panel of the LCD mainly comprises a substrate, an opposing substrate, liquid crystal material and a sealant. The liquid crystal material is sealed between the substrate and the opposing substrate through the sealant. In the process of fabricating the liquid crystal display panel, a liquid crystal filling process for filling the space bounded by the substrate, the opposing substrate and the sealant with liquid crystal has to be carried out. Therefore, the filling rate in the liquid crystal filling process and the liquid crystal uniformity after filling are some of the major factors affecting the quality of the LCD panel and the fabrication cost.

FIG. 1 shows a conventional liquid crystal filling process. FIG. 2 is a schematic cross-sectional view along line A-A′ of FIG. 1. As shown in FIGS. 1 and 2, the conventional liquid crystal filling process includes disposing a sealant 130 between a substrate 110 and an opposing substrate 120 to form a space 210. The space 210 has a filling gap 132. Then, the substrate 110, the opposing substrate 120 and the sealant 130 are disposed inside a vacuum chamber 220 with the vacuum chamber maintained at a low pressure. Under the low-pressure environment, the filling gap 132 is immersed in a liquid crystal tank 150. Then, the pressure within the vacuum chamber 220 is increased so that a pressure difference is formed between the vacuum chamber 220 and the space 210. As a result of the pressure difference and the capillary effect, liquid crystal material 140 is filled into the space 210 through the filling gap 132. Next, the filling gap 132 is sealed so that the liquid crystal material 140 is enclosed within the space bounded by the substrate 110, the opposing substrate 120 and the sealant 130.

However, the aforementioned liquid crystal filling process not only involves several complicated steps, but the filling rate of the liquid crystal material 140 is also slow. Thus, the process takes a lot of time and wastes manufacturing cost when an LCD panel is large or the gap between the substrate 110 and the opposing substrate 120 is small. In addition, the process may lead to a waste of liquid crystal material.

Another conventional technique having a faster liquid crystal filling rate is the one-drop-fill (ODF) process. FIGS. 3 and 4 show the flow in the conventional ODF process. As shown in FIG. 3, a sealant 130 is used to enclose a close display area 230 on a substrate 100. Then, a controllable drop amount of liquid crystal material 140 is dropped into the display area 230. After that, as shown in FIG. 4, an opposing substrate 120 is disposed on the sealant 130 so that the liquid crystal material 140 is sealed inside the enclosure formed by the substrate 110, the opposing substrate 120 and the sealant 130.

Although the aforementioned ODF method of dropping the liquid crystal material 140 into the display area 230 has a faster filling rate, the liquid crystal material often is non-uniformly distributed within the space enclosed by the substrate 110, the opposing substrate 120 and the sealant 130. Furthermore, spot-like or strip-like unevenness may easily occur on the LCD panel.

### SUMMARY OF THE INVENTION

Accordingly, at least one object of the present invention is to provide a liquid crystal filling device with a high filling rate for uniformly filling liquid crystal material within the space between two substrates.

Another object of the present invention is to provide a liquid crystal filling method to increase the filling rate and the uniformity for the liquid crystal material to be filled.

To achieve the aforementioned and other advantages and purposes in accordance with the present invention, as embodied and broadly described herein, the invention provides a liquid crystal filling device for forming a liquid crystal layer on a substrate. The liquid crystal filling device comprises a stage and a jet-print module. The substrate is mounted on the stage, and the jet-print module is used for spraying the liquid crystal material onto the substrate.

The aforementioned liquid crystal filling device can further comprises a liquid crystal storage unit, coupled to the jet-print module for providing the liquid crystal material to the jet-print module.

In addition, the stage may further comprise a first temperature control unit for controlling the temperature of a surface that supports the substrate, for example.

In the aforementioned liquid crystal filling device, the jet-print module may further comprise a second temperature control unit for controlling the temperature of the liquid crystal material sprayed from the jet-print module, for example.

In the aforementioned liquid crystal filling device, the jet-print module may further comprise a flow control unit for controlling the jet-print module and modulating the flow quantity of the liquid crystal material, for example. The flow control unit can be a nozzle with variable aperture, for example. Moreover, the aperture size of the variable aperture nozzle is dependent upon the dimension of the panel and the pitch between two neighboring pixels.

The aforementioned liquid crystal filling device may further comprise a frame and a sliding rail, for example. The jet-print module is disposed on the sliding rail so that the jet-print module can move relative to the stage.

In the aforementioned liquid crystal filling device, the moving speed of the jet-print module is dependent upon the size of the panel and the pitch between two neighboring pixels.

Furthermore, the present invention also provides a method for filling liquid crystal. First, a substrate and a jet-print module are provided. Then, a sealant is formed on the periphery of the substrate to define a liquid crystal filling area. Then, the liquid crystal material is sprayed inside the liquid crystal filling area from the jet-print module to form a liquid crystal layer on the substrate.

In the aforementioned liquid crystal filling method, after forming the liquid crystal layer, the method can further comprise a step of providing an opposing substrate and disposing the opposing substrate on the sealant so that the liquid crystal layer is sealed within the space bounded by the substrate, the opposing substrate and the sealant.

In the aforementioned liquid crystal filling method, the process of spraying the liquid crystal material onto the substrate can further comprise a step of controlling the temperature of the liquid crystal material, for example.

In the aforementioned liquid crystal filling method, the process of spraying the liquid crystal material on the substrate can further comprise a step of controlling the temperature of the substrate, for example.

In the aforementioned liquid crystal filling method, the process of spraying liquid crystal material on the substrate can further comprise a step of adjusting the moving speed of the jet-print module or the amount of the liquid crystal material from the jet-print module according to the area of the substrate or the pitch between two neighboring pixels, for example.

In the present invention, a jet-print module is used to spray the liquid crystal material onto a substrate. Hence, in comparison with the conventional method, the present invention is able to control more accurately the amount of the liquid crystal material sprayed onto the substrate and increase the uniformity of the sprayed liquid crystal layer on the substrate. Ultimately, display defects caused by the line or spot unevenness on the display panel can be prevented.

Furthermore, the present invention can utilize a temperature control unit to adjust the temperature of the liquid crystal material according to various liquid crystal materials. In this way, physical parameters (such as the surface tension and viscosity, etc.) can be optimized for the liquid filling process.

It is to be understood that both the foregoing general description and the following detailed description are exemplary, and are intended to provide further explanation of the invention as claimed.

### BRIEF DESCRIPTION OF THE DRAWINGS

While the specification concludes with claims particularly pointing out and distinctly claiming the subject matter which is regarded as the invention, the objects and features of the invention and further objects, features and advantages thereof will be better understood from the following description taken in connection with the accompanying drawings.

FIG. 1 is a diagram showing the conventional liquid crystal filling process.

FIG. 2 is a schematic cross-sectional view along line A-A′ of FIG. 1.

FIGS. 3 and 4 are schematic views of the process flow of the conventional one-drop-fill (ODF) method.

FIG. 5 is a diagram showing a liquid crystal filling device according to one preferred embodiment of the present invention.

FIG. 6 is a top view of a substrate according to one preferred embodiment of the present invention.

FIG. 7 is a flow chart showing steps for filling an enclosed area with the liquid crystal material according to one preferred embodiment of the present invention.

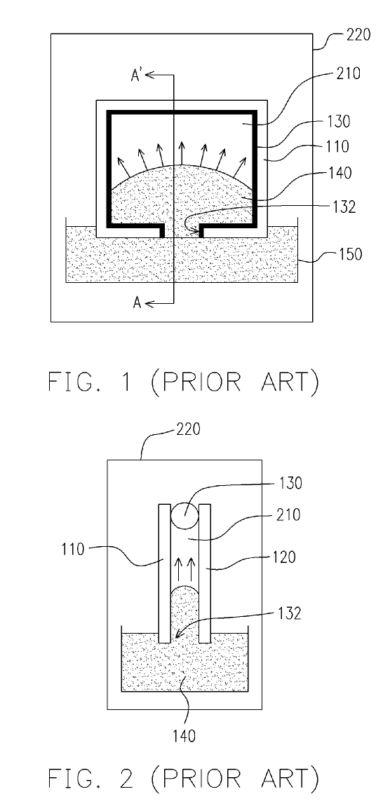

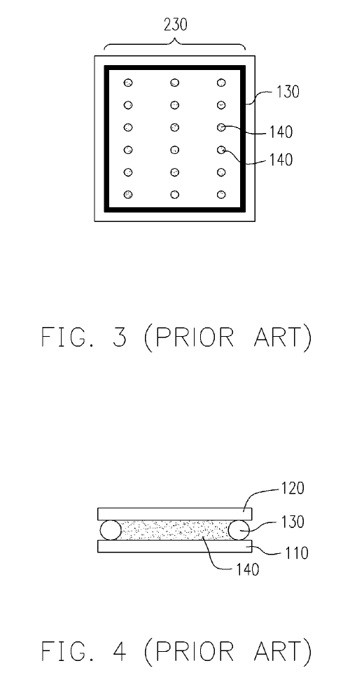

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 5 is a schematic drawing showing a liquid crystal filling device according to one preferred embodiment of the present invention. The liquid crystal filling device 300 mainly comprises a stage 310 and a jet-print module 330. The stage 310 is used for mounting a substrate 110 and the jet-print module 330 is used for spraying liquid crystal material 140 onto the substrate 110 through its motion relative to the stage 310.

In one preferred embodiment, the liquid crystal display device 300 may comprise a frame 320 having at least one sliding rail 325. The jet-print module 330 is arranged on the frame 320 for sliding relative to the stage 310 through the sliding rail 325. In addition, the sliding rail 325 can also be disposed at the bottom of the stage 310 so that the stage 310 can slide along the sliding rail 325 and move relative to the jet-print module 330. In addition, the distance from the jet-print module 330 to the substrate 110 can be changed, for example, by adjusting the height h of the frame 320.

The aforementioned liquid crystal display filling device 300 can further comprise a liquid crystal storage unit 340 and a pipe 350. One end of the pipe 350 is coupled to the liquid crystal storage unit 340 while the other end of the pipe 350 is coupled to the jet-print module 330. Therefore, the liquid crystal storage unit 340 can supply liquid crystal material 140 to the jet-print module 330 through the pipe 350.

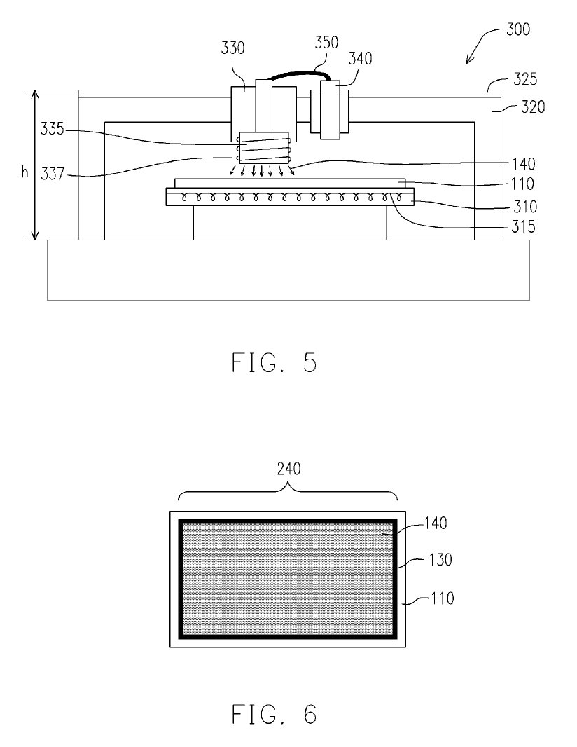

With the aforementioned liquid crystal filling device 300 deploying the jet-print module 330 as a liquid crystal filling tool, the liquid crystal material 140 sprayed on the substrate 110 can become more uniform in comparison with the conventional technique. The operation of the liquid crystal filling device 300 is further explained as follows. FIG. 6 is a top view of a substrate according to one preferred embodiment of the present invention. Before the substrate 110 is mounted on the stage 310, the sealant 130 is disposed on the periphery of the substrate 110 so that a liquid crystal filling area 240 is defined. Thereafter, the substrate along with the sealant 130 is disposed on the stage 310.

Then, the jet-print module 330 moves along the sliding rail 325 relative to the substrate 110 and sprays the liquid crystal material 140 onto the substrate 110 within the liquid crystal filling area 240. The speed of the jet-print module 330 moving relative to the substrate 110 is dependent upon the size of the liquid crystal filling area 240 of the substrate 110 and the pitch between two neighboring pixels of the desired liquid crystal display panel. Because the movement of the liquid crystal material 140 sprayed on the substrate 110 is constrained by the sealant 130, the liquid crystal material 140 will stay within the liquid crystal filling area 240 to form a liquid crystal layer.

It should be noted that the jet-print module 330 utilizes ink jet printing mechanism to spread the liquid crystal material 140 onto the substrate 110. Thus, the jet-print module 330 not only sprays a highly uniform layer of the liquid crystal material 140 on the liquid crystal filling area 240, but also accurately controls the quantity of the sprayed liquid crystal material 140 in comparison with the conventional technique.

To control the amount of the sprayed liquid crystal material 140 and enhance the degree of uniformity of the sprayed liquid crystal even further, the above jet-print module 330 can further comprises a flow control unit 335 for adjusting an output amount of the liquid crystal material 140. The flow control unit 335 can be a nozzle with a variable aperture, for example. In the present embodiment, the opening extent of the variable aperture nozzle can be adjusted according to the size of the liquid crystal filling area 240 on the substrate 110 and the pitch between two neighboring pixel of the desired liquid crystal display panel. With a more accurate control on the amount of liquid crystal material 140 sprayed from the jet-print module 330, both the uniformity and the filling accuracy of the liquid crystal material 140 sprayed onto the substrate 110 can be enhanced.

In addition, the temperature of the liquid crystal material 140 is one of the most important parameters that affect the uniformity of the sprayed liquid crystal. Therefore, the jet-print module 330 can further comprise a temperature control unit 337 for controlling the temperature of the output liquid crystal material. Furthermore, the stage 310 can also comprises another temperature control unit 315, so that the temperature of the liquid crystal material sprayed onto the substrate 110 can be adjusted. The temperature control units 315 and 337 can be implemented by using a heating plate, a heating block or other heating elements, for example.

For example, in the process of filling with the liquid crystal material 140, whether the liquid crystal material 140 sprayed on the substrate 110 is uniform or not is closely related to the physical properties of the liquid crystal material 140, such as surface tension and viscosity, etc. Furthermore, these physical properties are directly related to the temperature of the liquid crystal material 140. Therefore, by controlling the temperature of the liquid crystal material 140 through the temperature control unit 315, 355 or both, the surface tension and viscosity of the liquid crystal material 140 can be indirectly controlled and optimized. Ultimately, the liquid crystal material 140 will have the desired mobility during the liquid crystal filling process to form a liquid crystal layer with desire thickness and uniformity.

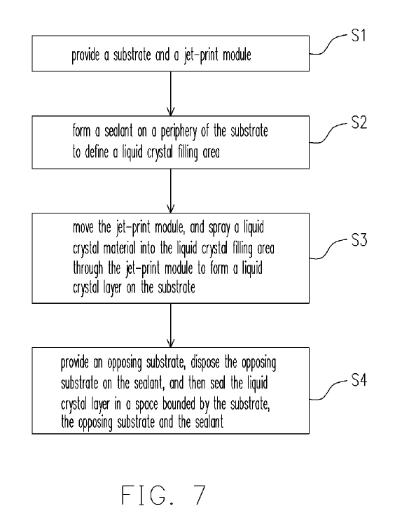

According to the aforementioned device, the present invention also provides a liquid crystal filling method. FIG. 7 is a flow chart showing steps for filling an enclosed area with liquid crystal according to one preferred embodiment of the present invention. As shown in FIG. 7, the liquid crystal filling method includes following steps. First, in step S1, a substrate and a jet-print module are provided. In step S2, a sealant is formed on the periphery of the substrate to define a liquid crystal filling area. The sealant can be formed, for example, by using a dispenser, performing a screen printing operation or spreading sealant onto the substrate by some other methods.

In step S3, the liquid crystal material is sprayed onto the substrate through the jet-print module. During the spraying process, the jet-print module is driven to move at a suitable speed relative to the substrate so that the liquid crystal material can sprayed out evenly onto the substrate. The liquid crystal material can be, for example, a nematic liquid crystal, cholesteric liquid crystal or other type of liquid crystal material. Then, in step S4, an opposing substrate is provided to dispose upon the sealant so that the liquid crystal layer is enclosed within the space bounded by the substrate, the opposing substrate and the sealant.

The device and method according to the present invention is suitable for filling displays including, for example, thin film transistor liquid crystal display (TFT-LCD) (amorphous silicon and low temperature polysilicon), high temperature polysilicon (HTPS) and liquid crystal on silicon (LCoS) with liquid crystal. In fact, the device and method of the present invention can be applied to any type of display devices that require filling the liquid crystal material.

In summary, the present invention uses a jet-print module to spray the liquid crystal material onto a substrate. Therefore, the amount of the sprayed liquid crystal material can be accurately controlled so that the layer of liquid crystal sprayed onto the substrate can become more uniform. In this way, formation of spot or line unevenness formed on the liquid crystal display panel can be avoided. By using the jet-print module of the present invention, the amount of the liquid crystal material needed for filling a liquid crystal display panel can be also saved and the time needed for filling the display panel with the liquid crystal is reduced.

In addition, the amount of the liquid crystal material output from the jet-print module can be controlled through the flow control unit so that the liquid crystal material sprayed onto the substrate can become more uniform.

Moreover, the temperature of the liquid crystal material can be controlled through the temperature control unit disposed on the jet-print module, the stage or both. Hence, the liquid crystal material sprayed onto the substrate can become more uniform.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A liquid crystal filling device for forming a liquid crystal layer onto a substrate, comprising:
a stage for mounting the substrate; and
a jet-print module disposed over the stage, wherein the jet-print module is used for spraying a liquid crystal material onto the substrate.

2. The liquid crystal filling device of claim 1, further comprising a liquid crystal storage unit coupled to the jet-print module for supplying the liquid crystal material to the jet-print module.

3. The liquid crystal filling device of claim 1, wherein the stage further comprises a first temperature control unit for controlling a temperature of the substrate on the stage.

4. The liquid crystal filling device of claim 1, wherein the jet-print module further comprises a second temperature control unit for controlling a temperature of the liquid crystal material sprayed from the jet-print module.

5. The liquid crystal filling device of claim 1, wherein the jet-print module further comprises a flow control unit for adjusting an amount of liquid crystal material.

6. The liquid crystal filling device of claim 5, wherein the flow control unit comprises a nozzle with variable aperture.

7. The liquid crystal filling device of claim 6, wherein an aperture size of the nozzle with variable aperture is set according to a display panel size and a pitch between two neighboring pixels.

8. The liquid crystal filling device of claim 1, further comprising a frame having a sliding rail.

9. The liquid crystal filling device of claim 8, wherein a moving speed of the jet-print module is set according to a display panel size and a pitch between two neighboring pixels.

10. A liquid crystal filling method, comprising steps of:
providing a substrate and a jet-print module;
forming a sealant on a periphery of the substrate to define a liquid crystal filling area; and
spraying a liquid crystal material into the liquid crystal filling area through the jet-print module to form a liquid crystal layer on the substrate.

11. The liquid crystal filling method of claim 10, further comprising providing an opposing substrate and disposing the opposing substrate on the sealant so that the liquid crystal layer is sealed inside a space bounded by the substrate, the opposing substrate and the sealant.

12. The liquid crystal filling method of claim 10, wherein the step of spraying the liquid crystal material onto the substrate further comprises controlling a temperature of the liquid crystal material.

13. The liquid crystal filling method of claim 10, wherein the step of spraying the liquid crystal material onto the substrate further comprises controlling a temperature of the substrate.

14. The liquid crystal filling method of claim 10, wherein the step of spraying the liquid crystal material onto the substrate further comprises adjusting a moving speed of the jet-print module or a flow amount of the liquid crystal material from the jet-print according to an area of the substrate or a pitch between two neighboring pixels.
